(19) United States
(12) Patent Application Publication
(10) Pub. No.: US 2024/0320916 A1
(43) Pub. Date: Sep. 26, 2024

(54) INFORMATION PROCESSING DEVICE, INFORMATION PROCESSING METHOD, AND PROGRAM

(71) Applicant: Sony Semiconductor Solutions Corporation, Atsugi-shi, Kanagawa (JP)

(72) Inventor: Hiromasa DOI, Kanagawa (JP)

(73) Assignee: Sony Semiconductor Solutions Corporation, Atsugi-shi, Kanagawa (JP)

(21) Appl. No.: 18/576,422

(22) PCT Filed: Feb. 25, 2022
(86) PCT No.: PCT/JP2022/007805

§ 371 Date: Jan. 4, 2024

(30) Foreign Application Priority Data
Jul. 12, 2021 (JP) 2021-115287

(51) Int. Cl. G06T 17/20; G06T 7/50; G06T 7/62; G06T 7/90

(52) U.S. Cl. CPC G06T 17/20; G06T 7/50; G06T 7/62; G06T 7/90; G06T 2207/10024

(57) ABSTRACT

The present disclosure relates to an information processing device, an information processing method, and a program that are capable of extending the range of video expression. The information processing device includes a processing unit that performs processing for replacing an area corresponding to a real space with associated contents on the basis of a scan result obtained by a 3D scan of the real space, wherein the processing unit associates the contents with the area corresponding to the real space, on the basis of information about at least one of an object, a shape, a size, a color, and a material in the real space. The present disclosure is applicable to, for example, an electronic device including various sensors.

### TECHNICAL FIELD

The present disclosure relates to an information processing device, an information processing method, and a program and particularly relates to an information processing device, an information processing method, and a program that are capable of extending the range of video expression.

### BACKGROUND ART

In order to use the recognition results of an environmental mesh and a 3D object for video shooting of a game or an SNS (Social Networking Service), in some cases, augmented reality (AR) videos are generated using various kinds of video processing. As a technique for generating an augmented reality video, for example, a technique disclosed in PTL 1 is known.

### CITATION LIST

### Patent Literature

### [PTL 1]

JP 2020-64592A

### SUMMARY

### Technical Problem

In the generation of an augmented reality video, a technique for extending the range of video expression has been demanded.

In view of such situations, the present disclosure is directed to extend the range of video expression.

### Solution to Problem

In the an information processing device according to an aspect of the present disclosure is an information processing device including a processing unit that performs processing for replacing an area corresponding to a real space with associated contents on the basis of a scan result obtained by a 3D scan of the real space, wherein the processing unit associates the contents with the area corresponding to the real space, on the basis of information about at least one of an object, a shape, a size, a color, and a material in the real space.

An information processing method according to an aspect of the present disclosure is an information processing method causing an information processing device to perform processing for replacing an area corresponding to a real space with associated contents on the basis of a scan result obtained by a 3D scan of the real space, and associate the contents with the area corresponding to the real space, on the basis of information about at least one of an object, a shape, a size, a color, and a material in the real space.

A program according to an aspect of the present disclosure is a program causing a computer to function as an information processing device including a processing unit that performs processing for replacing an area corresponding to a real space with associated contents on the basis of a scan result obtained by a 3D scan of the real space, wherein the processing unit associates the contents with the area corresponding to the real space, on the basis of information about at least one of an object, a shape, a size, a color, and a material in the real space.

In the information processing device, the information processing method, and the program according to an aspect of the present disclosure, an area corresponding to a real space is replaced with associated contents on the basis of a scan result obtained by a 3D scan of the real space, and the contents area replaced with the area corresponding to the real space, on the basis of information about at least one of an object, a shape, a size, a color, and a material in the real space.

The information processing device according to an aspect of the present disclosure may be an independent device or may be an internal block constituting a device.

### BRIEF DESCRIPTION OF DRAWINGS

FIG. 1 is a block diagram illustrating a configuration example of an embodiment of an information processing device to which the present disclosure is applied.

FIG. 2 is a block diagram illustrating a functional configuration example of the information processing device to which the present disclosure is applied.

FIG. 3 is a block diagram illustrating a detailed configuration example of an AR processing unit.

FIG. 4 is a flowchart showing a flow of processing performed by the information processing device to which the present disclosure is applied.

FIG. 5 is a flowchart for describing the detail of AR processing.

FIG. 6 illustrates a first example of the display of an AR application.

FIG. 7 illustrates a second example of the display of the AR application.

FIG. 8 illustrates a third example of the display of the AR application.

FIG. 9 illustrates a configuration example of a system including a device for performing processing to which the present disclosure is applied.

FIG. 10 is a block diagram illustrating a configuration example of an electronic device.

FIG. 11 is a block diagram illustrating a configuration example of an edge server or a cloud server.

FIG. 12 is a block diagram illustrating a configuration example of an optical sensor.

### DESCRIPTION OF EMBODIMENTS

### 1. Embodiment of Present Disclosure

### (Device Configuration)

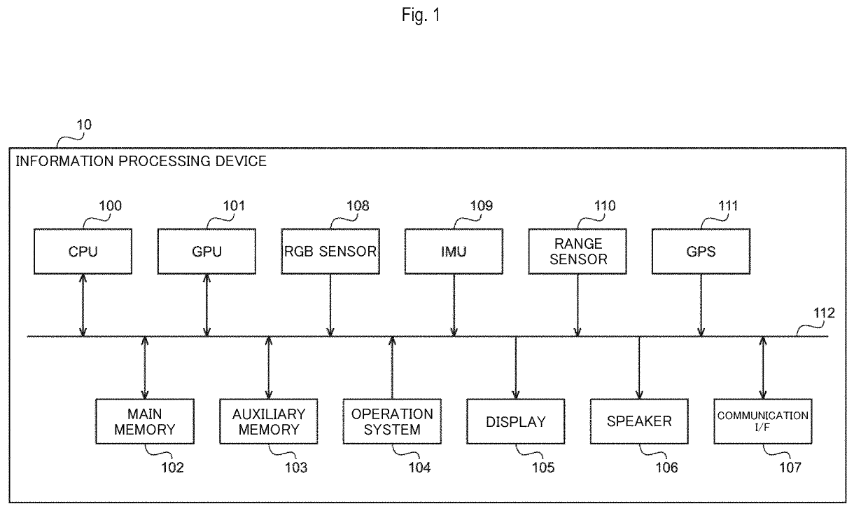

FIG. 1 is a block diagram illustrating a configuration example of an embodiment of an information processing device to which the present disclosure is applied.

An information processing device 10 is an electronic device, e.g., a smartphone, a tablet-type terminal, or a mobile phone.

The information processing device 10 includes a CPU (Central Processing Unit) 100 that controls an operation of each unit and performs various kinds of processing, a GPU (Graphics Processing Unit) 101 that specializes in image processing and parallel processing, a main memory 102, e.g., a DRAM (Dynamic Random Access Memory), and an auxiliary memory 103, e.g., a flash memory. The units and memories are connected to one another via a bus 112.

The auxiliary memory 103 records a program, various parameters, and data. The CPU 100 develops the program and parameters, which are recorded in the auxiliary memory 103, into the main memory 102 and executes the program. When the program is executed, data recorded in the auxiliary memory 103 can be used as necessary. The GPU 101 can similarly execute the program recording in the auxiliary memory 103.

In the information processing device 10, an operation system 104 that includes physical buttons and a touch panel, a display 105 that displays text information and video, a speaker 106 that outputs a sound, and a communication I/F 107, e.g., a communication module compliant with a predetermined communication scheme are additionally connected to the bus 112. As a communication scheme, for example, mobile communication systems such as 5G (5th Generation) and a wireless LAN (Local Area Network) are included.

Moreover, in the information processing device 10, an RGB sensor 108, an IMU (Inertial Measurement Unit) 109, a range sensor 110, and a GPS (Global Positioning System) 111 are connected to the bus 112.

The RGB sensor 108 is an image sensor including an image sensor, e.g., a CMOS (Complementary Metal Oxide Semiconductor) image sensor. The RGB sensor 108 captures an image of an object and outputs the captured image. As a captured image, an RGB image in which one pixel is expressed by three primary colors: R (red), G (green), and B (blue) is outputted.

The IMU 109 is an inertial measurement unit including a three-axis accelerometer and a three-axis gyro. The IMU 109 measures a three-dimensional acceleration and an angular velocity and outputs acceleration information obtained by the measurement.

The range sensor 110 is a range sensor, e.g., a ToF (Time of Flight) sensor. The ToF sensor may be compliant with any one of a dToF (direct Time of Flight) scheme and an iToF (indirect Time of Flight) scheme. The range sensor 110 measures a distance to an object and outputs distance measurement information obtained by the measurement. Moreover, the range sensor 110 may be a structured light sensor, a LiDAR (Light Detection and Ranging) sensor, or a stereo camera for measuring a distance by using a plurality of sensors.

The GPS 111 measures the current position by receiving a signal from a GPS satellite and outputs location information obtained by the measurement. The GPS is an example of a satellite positioning system. Other satellite positioning systems may be used instead.

A hardware configuration illustrated in FIG. 1 is merely exemplary and other constituent elements may be added or some of the constituent elements may be omitted. In FIG. 1, the CPU 100 and the GPU 101 may be each configured as a SoC (System on a Chip). In the case where the CPU 100 executes a program for AR processing, which will be described later, the GPU 101 may be omitted.

### (Functional Configuration)

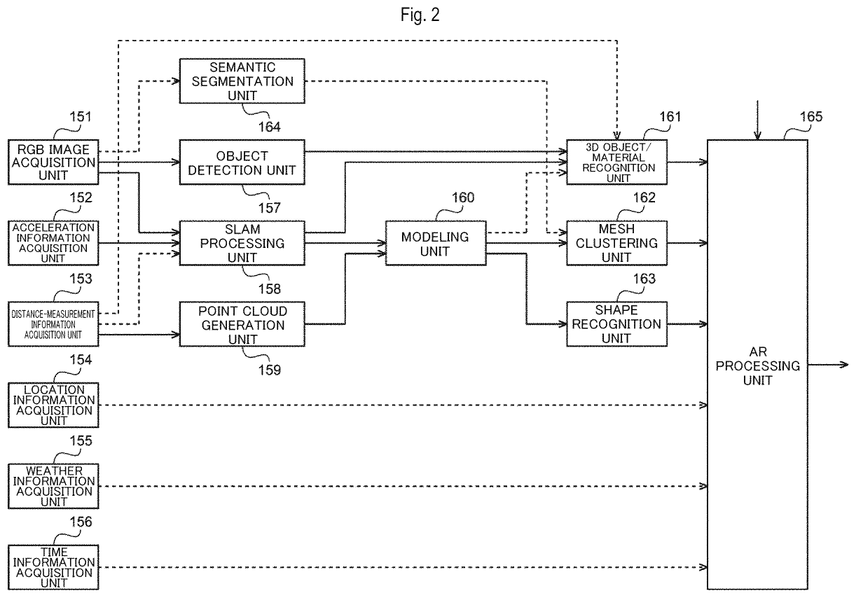

FIG. 2 is a block diagram illustrating a functional configuration example of the information processing device to which the present disclosure is applied.

In FIG. 2, the information processing device 10 includes an RGB image acquisition unit 151, an acceleration information acquisition unit 152, a distance-measurement information acquisition unit 153, a location information acquisition unit 154, a weather information acquisition unit 155, a time information acquisition unit 156, an object detection unit 157, a SLAM processing unit 158, a point cloud generation unit 159, a modeling unit 160, a 3D object/material recognition unit 161, a mesh clustering unit 162, a shape recognition unit 163, a semantic segmentation unit 164, and an AR processing unit 165. These blocks are configured as processing units that perform processing for augmented reality (AR).

The RGB image acquisition unit 151 acquires an RGB image captured by the RGB sensor 108 and supplies the image to the object detection unit 157, the SLAM processing unit 158, and the semantic segmentation unit 164.

The acceleration information acquisition unit 152 acquires acceleration information measured by the IMU 109 and supplies the information to the SLAM processing unit 158.

The distance-measurement information acquisition unit 153 acquires distance measurement information measured by the range sensor 110 and supplies the information to the SLAM processing unit 158, the point cloud generation unit 159, and the 3D object/material recognition unit 161.

The distance measurement information includes a depth image and an IR reflectivity information. To the SLAM processing unit 158 and the point cloud generation unit 159, a depth image is supplied as distance measurement information. IR reflectivity information is supplied to the 3D object/material recognition unit 161.

The depth image is, for example, a depth map having a depth value for each pixel. The IR reflectivity information is, for example, an infrared image having an IR (infrared) value for each pixel. For example, if the range sensor 110 is a ToF sensor, a distance to a surface of a target object is calculated according to a time from the irradiation of infrared light from a light-emitting device to the target object to the return of the reflected light. In this method, images are generated from reflected light (infrared light) that is received by a light receiving element, so that an infrared image is obtained by accumulating the images.

The location information acquisition unit 154 acquires location information measured by the GPS 111 and supplies the information to the AR processing unit 165. The location information is information indicating the position of the information processing device 10.

The weather information acquisition unit 155 acquires weather information from a server on a network, e.g., the Internet via the communication I/F 107 and supplies the information to the AR processing unit 165. The weather information includes information indicating fine, cloudy, and rainy weathers and information about an air temperature or the like.

The time information acquisition unit 156 acquires time information including a current time and a date and supplies the information to the AR processing unit 165. As the time information, time information managed in the information processing device 10 may be acquired or time information managed by a server on a network, e.g., the Internet may be acquired through the communication I/F 107.

The object detection unit 157 detects an object included in an RGB image supplied from the RGB image acquisition unit 151 and supplied the detection result to the 3D object/material recognition unit 161.

The RGB image from the RGB image acquisition unit 151, the acceleration information from the acceleration information acquisition unit 152, and the depth image from the distance-measurement information acquisition unit 153 are supplied to the SLAM processing unit 158. The SLAM processing unit 158 performs SLAM (Simultaneous Localization and Mapping) processing on the basis of the RGB image, the acceleration information, and the depth image.

In the SLAM processing, processing such as self-location estimation using the RGB image and the acceleration information is performed and attitude information about the position and orientation of the information processing device 10 (RGB sensor 108) is obtained. The SLAM processing unit 158 supplies the attitude information to the 3D object/material recognition unit 161 and the modeling unit 160.

In the SLAM processing, a depth image is not always necessary. However, the accuracy of the SLAM processing can be improved by using a depth image, which serves as distance measurement information, for solving scale. Moreover, in the SLAM processing, the attitude information may be calculated without using the acceleration information.

The point cloud generation unit 159 generates a point cloud on the basis of a depth image supplied from the distance-measurement information acquisition unit 153 and supplies the point cloud to the modeling unit 160. The point cloud is point group data including information about three-dimensional coordinates and colors or the like.

The attitude information from the SLAM processing unit 158 and the point cloud from the point cloud generation unit 159 are supplied to the modeling unit 160. The modeling unit 160 performs modeling on the basis of the attitude information and the point cloud.

In the modeling, an environmental mesh that expresses the environment of a real space by a polygon mesh structure is generated. In other words, the environment of a real space is three-dimensionally scanned and is modeled by the polygon mesh structure. The modeling unit 160 supplies the environmental mesh to the 3D object/material recognition unit 161, the mesh clustering unit 162, and the shape recognition unit 163.

The IR reflectivity information from the distance-measurement information acquisition unit 153, the object detection result from the object detection unit 157, the attitude information from the SLAM processing unit 158, and the environmental mesh from the modeling unit 160 are supplied to the 3D object/material recognition unit 161. The 3D object/material recognition unit 161 performs recognition for recognizing a 3D object and a material on the basis of the attitude information, the object detection result, the IR reflectivity information, and the environmental mesh.

In the recognition of a 3D object, objects such as a chair, a sofa, a bed, a television, a person, a PET bottle, and a book in a real space are recognized by using the object detection result (RGB image) and information including the attitude information. In the recognition of a material, materials such as wood, a metal, a stone, a fabric, and a cloth are recognized by using information including the object detection result (RGB image), the IR reflectivity information, and the environmental mesh. The 3D object/material recognition unit 161 supplies the recognition results of the 3D object and the material to the AR processing unit 165.

In the recognition of a material, the use of the IR reflectivity information and the environmental mesh is not always necessary. The amount of information is increased by using the IR reflectivity information (infrared image) as well as information about an RGB image when a material is recognized, so that the material can be recognized with higher accuracy. In the recognition of a material, the recognition result of a shape recognized by the shape recognition unit 163 may be additionally used.

The mesh clustering unit 162 performs mesh clustering on the basis of the environmental mesh supplied from the modeling unit 160 and supplies the mesh clustering result to the AR processing unit 165.

In the mesh clustering, environmental meshes are grouped by using a clustering method into a floor, a ceiling, a wall, a window, a door, a chair, a sofa, and a bed or the like. In other words, a polygon mesh is information including a set of vertexes for defining the shape of an object. The group (including a floor) of the vertexes is recognized to group the vertexes.

When the mesh clustering is performed, the recognition result of semantic segmentation by the semantic segmentation unit 164 may be used. In the semantic segmentation, a set of pixels forming a characteristic category can be recognized based on an RGB image.

The shape recognition unit 163 performs recognition for recognizing a shape and a size on the basis of the environmental mesh supplied from the modeling unit 160 and supplies the recognition result of the shape and the size to the AR processing unit 165.

In the recognition of a shape and a size, the specific shapes and sizes of, for example, a space, a protrusion, and a recess are recognized. For example, as a shape and a size of a space, the presence of a large space is recognized. Specifically, an environmental mesh is expressed by a polygon mesh including a set of vertexes or the like, so that specific shapes such as a square and a recess can be recognized from the polygon mesh. In the recognition, whether a cluster of polygon meshes agrees with a specific shape is determined. The determination may be rule-based or may be made by using a learned model through machine learning using learning data such as an RGB image.

The recognition result of a 3D object and a material from the 3D object/material recognition unit 161, the clustering result from the mesh clustering unit 162, and the recognition result of a shape and a size from the shape recognition unit 163 are supplied to the AR processing unit 165. The recognition result of the 3D object includes information about an object (a chair, a sofa or the like) and a color. In other words, information about an object, a shape, a size, a color, and a material is supplied to the AR processing unit 165 with the clustering result. The information about at least one of an object, a shape, a size, a color, and a material may be supplied.

Furthermore, location information from the location information acquisition unit 154, weather information from the weather information acquisition unit 155, and time information from the time information acquisition unit 156 are supplied to the AR processing unit 165.

The AR processing unit 165 performs AR processing for generating an augmented reality (AR) video on the basis of the recognition result of a 3D object and a material, the clustering result, the recognition result of a shape and a size, the location information, the weather information, and the time information. During AR processing, as appropriate, the AR processing unit 165 can read and use data (data on contents such as an AR object) recorded in the auxiliary memory 103.

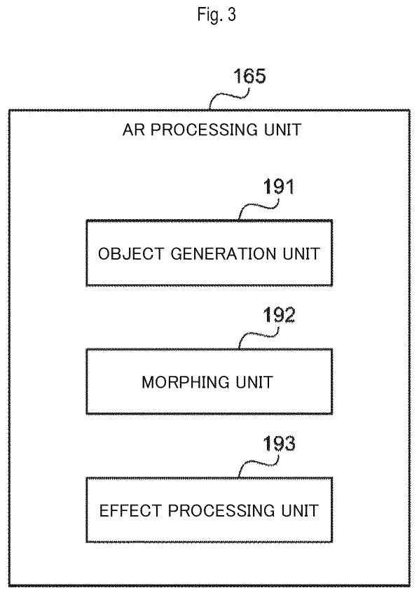

FIG. 3 illustrates a detailed configuration example of the AR processing unit 165. In FIG. 3, the AR processing unit 165 includes an object generation unit 191, a morphing unit 192, and an effect processing unit 193.

The object generation unit 191 generates an AR object used as an augmented reality video. For example, as AR objects, objects including vehicles such as a ship, buildings such as a house, plants such as a tree and a flower, living creatures such as an animal and a bug, a balloon, a rocket, and a person (character) are generated.

The morphing unit 192 performs morphing and replaces polygon meshes and objects. In the morphing, processing is performed to display a video that is naturally deformed from an object to another. For example, in the replacement of polygon meshes, polygon meshes grouped by mesh clustering are replaced with images of, for example, the sky, the sea, a waterfall, and a ground surface. In the replacement of objects, a person recognized as a 3D object is replaced with a CG (Computer Graphics) model corresponding to background information.

The effect processing unit 193 performs effect processing using VFX (Visual Effects) and obtains a video effect that is unrealistic in a real space. For example, as VFX, processing may be performed to change lighting according to daytime or nighttime hours and weathers such as a cloudy weather or create an effect corresponding to a weather, e.g., rain or snow over a screen.

The object generation unit 191, the morphing unit 192, and the effect processing unit 193 can use various kinds of information during the processing of the units. For example, in the effect processing unit 193, contents can be processed, for example, lighting can be changed according to conditions such as a location, a weather, and a time period based on additional information including location information, weather information, and time information. By using information including location information, weather information, and time information, an augmented reality video can be generated according to the information.

In the information processing device 10 configured thus, an area corresponding to a real space is processed to be replaced with associated contents by processing units including the AR processing unit 165 on the basis of a scan result obtained by a 3D scan of a real space. In the association of the contents, the contents are associated with an area corresponding to a real space on the basis of information about at least one of an object, a shape, a size, a color, and a material in a real space.

More specifically, the AR processing unit 165 associates the contents with an area having a specific object on the basis of information about the object in a real space. The object is recognized on the basis of an RGB image captured by the RGB sensor 108. Moreover, the AR processing unit 165 associates contents with an area having a specific shape on the basis of information about the shape in a real space. The shape is recognized on the basis of an RGB image captured by the RGB sensor, acceleration information measured by the IMU 109, and distance measurement information measured by the range sensor 110.

The AR processing unit 165 associates contents with an area having a specific size on the basis of information about the size in a real space. The size is recognized on the basis of an RGB image captured by the RGB sensor, acceleration information measured by the IMU 109, and distance measurement information measured by the range sensor 110. The AR processing unit 165 associates contents with an area having a specific color on the basis of information about the color in a real space. The color is recognized on the basis of an RGB image captured by the RGB sensor 108.

The AR processing unit 165 associates contents with an area having a specific material on the basis of information about the material in a real space. The material is recognized on the basis of an RGB image captured by the RGB sensor 108 and distance measurement information measured by the range sensor 110.

In the AR processing unit 165, object generation by the object generation unit 191 and effect processing by the effect processing unit 193 are processing performed as necessary. In FIG. 2, arrows between the blocks show the flows of signals and data that are exchanged between the blocks. Broken line arrows indicate that flows of signals and data are not necessary.

### (Flow of Processing)

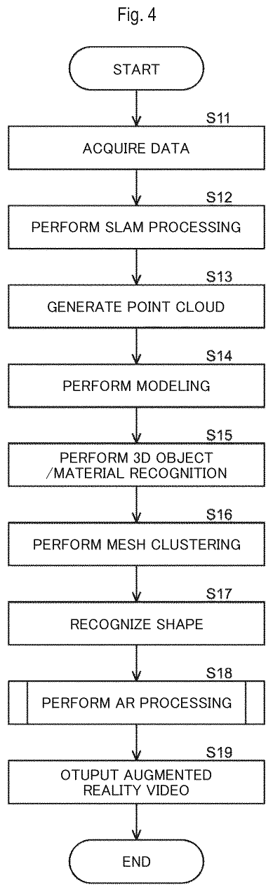

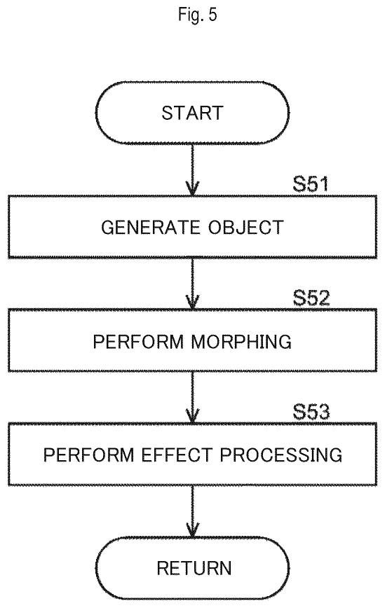

Referring to the flowcharts of FIGS. 4 and 5, the flow of processing performed by the information processing device to which the present disclosure is applied will be described below. In the information processing device 10, e.g., a smartphone, an AR application for displaying an augmented reality video is downloaded from a server on the Internet and is started. For example, when a predetermined user operation is performed at the start of the AR application, processing indicated by the flowchart of FIG. 4 is performed in the information processing device 10.

In step S11, the acquisition units acquire data as necessary. An RGB image, acceleration information, and distance measurement information are acquired by the RGB image acquisition unit 151, the acceleration information acquisition unit 152, and the distance-measurement information acquisition unit 153, respectively. Furthermore, location information, weather information, and time information are acquired by the location information acquisition unit 154, the weather information acquisition unit 155, and the time information acquisition unit 156, respectively.

In step S12, the SLAM processing unit 158 performs SLAM processing on the basis of the RGB image, the acceleration information, and a depth image and calculates attitude information. In the SLAM processing, the acceleration information and the depth image are used as appropriate and the attitude information is calculated by using at least the RGB image.

In step S13, the point cloud generation unit 159 generates a point cloud on the basis of the depth image.

In step S14, the modeling unit 160 performs modeling on the basis of the attitude information and the point cloud and generates an environmental mesh.

In step S15, the 3D object/material recognition unit 161 performs recognition for recognizing a 3D object and a material on the basis of the attitude information, an object detection result, IR reflectivity information, and the environmental mesh.

In the recognition of a 3D object, objects in a real space are recognized by using the object detection result (RGB image) and information including the attitude information. In the recognition of a material, materials are recognized by using information including the object detection result (RGB image), the IR reflectivity information, and the environmental mesh. In the recognition of a material, the IR reflectivity information and the environmental mesh are used as appropriate.

In step S16, the mesh clustering unit 162 performs mesh clustering on the basis of the environmental mesh. In the mesh clustering, environmental meshes (a cluster of polygon meshes) are grouped by using a clustering method. When the mesh clustering is performed, the recognition result of semantic segmentation may be used.

In step S17, the shape recognition unit 163 performs recognition for recognizing a shape and a size on the basis of the environmental mesh. In the recognition of a shape, an environmental mesh is expressed by a polygon mesh including a set of vertexes or the like, so that specific shapes such as a square and a recess and the sizes can be recognized from the polygon mesh.

In step S18, the AR processing unit 165 performs AR processing on the basis of information including the recognition result of a 3D object and a material, the recognition result of a shape and a size, and the clustering result. In the AR processing, additional information including location information, weather information, and time information can be used as appropriate. Referring to the flowchart of FIG. 5, the detail of the AR processing will be described below.

In step S51, the object generation unit 191 performs object generation for generating AR objects such as a ship and a house.

In step S52, the morphing unit 192 performs morphing such as the replacement of polygon meshes and the replacement of objects.

In the replacement of polygon meshes, polygon meshes grouped by mesh clustering are replaced with images of the sky and the sea. In the replacement of objects, a person recognized as a 3D object is replaced with a CG model or the like.

in step S53, the effect processing unit 193 performs effect processing including a change of lighting according to conditions such as a time period and a weather and the creation of an effect over the screen.

As described above, as AR processing, an AR object is generated by object generation, polygon meshes and objects are replaced by morphing, and lighting is changed or an effect is created over the screen by effect processing, so that an augmented reality video is generated.

Returning to FIG. 4, in step S19, the AR processing unit 165 outputs AR video data obtained by AR processing to the display 105. Thus, an augmented reality video generated by the AR processing unit 165 is displayed on the display 105.

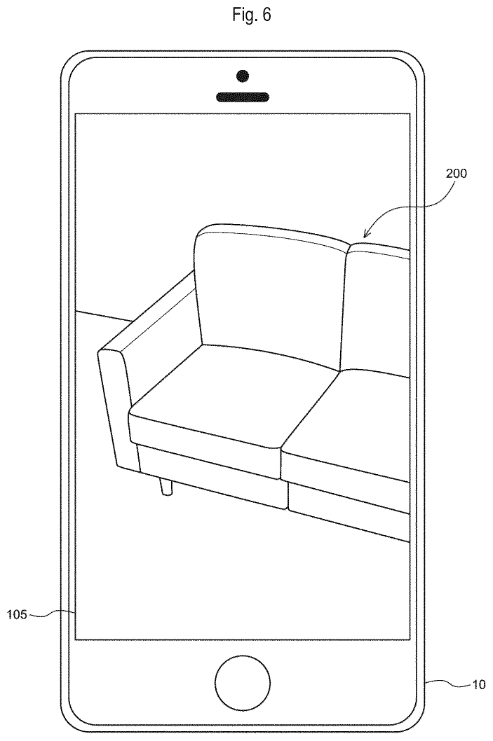

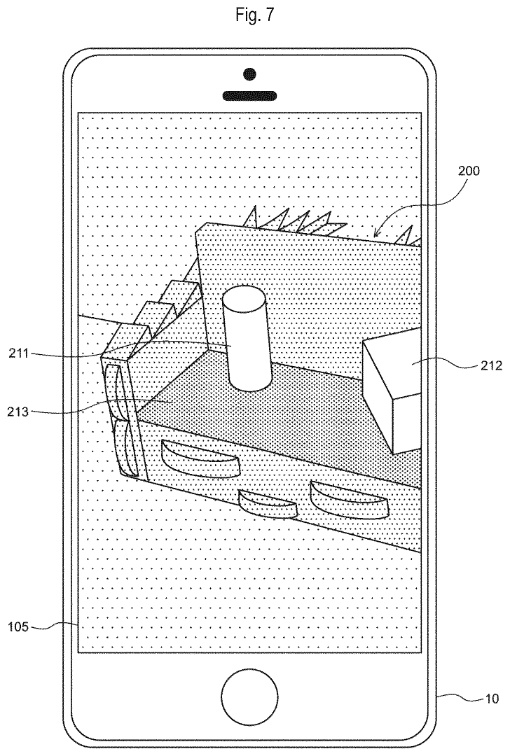

FIGS. 6 and 7 illustrate display examples of an AR application. As shown in FIG. 6, it is assumed that a user operating the information processing device 10, e.g., a smartphone starts the AR application to capture an image of a sofa in a room. At this point, in the information processing device 10, a video including a sofa 200 is displayed on the display 105.

In the information processing device 10, the processing shown in the flowcharts of FIGS. 4 and 5 is performed by the AR application, so that an augmented reality video is displayed as shown in FIG. 7. For example, objects 211 and 212 are displayed by performing object generation and morphing as AR processing. By performing morphing as AR processing, polygon meshes that define the shapes of a floor and a wall as well as the sofa 200 are replaced with, for example, the sky and a ground surface.

Specifically, an augmented reality video is displayed such that the seat part of the sofa 200 is replaced with an image 213 of a ground surface or the like, and the objects 211 and 212 of buildings or the like are placed on the image 213. The objects 211 and 212 may be AR objects generated by object generation or objects such as CG models replaced by object replacement through morphing. Additionally, for example, steps may be replaced with a waterfall, a carpet may be replaced with a green field, a PET bottle on a table may be replaced with a rocket, or a wall-mounted clock may be replaced with the sun.

The processing performed by the information processing device to which the present disclosure is applied was described. In the information processing device to which the present disclosure is applied, the amount of information and the accuracy of information used for object generation and morphing are increased by performing the processing shown in the flowcharts of FIGS. 4 and 5. Thus, the range of video expression of augmented reality can be extended. Moreover, the effect of eliminating unnaturalness in video is obtained by extending the range of video expression of augmented reality.

In order to use the recognition results of an environmental mesh and a 3D object for video shooting of a game or an SNS, augmented reality videos have been recently generated using processing such as CG object generation, morphing, changing of lighting, and VFX processing. In the placement of a CG object, the result of mesh clustering or the recognition result of a 3D object has been mainly used. However, in some cases, the range of video expression of augmented reality is reduced or the attraction of video is lost because of information shortage caused by an insufficient number of mesh clustering results with poor accuracy or an insufficient number of recognition results of 3D objects with poor accuracy.

In contrast, in the information processing device to which the present disclosure is applied, when an area corresponding to a real space is replaced with associated contents on the basis of a scan result obtained by a 3D scan of a real space, the contents are associated with an area corresponding to a real space on the basis of information about at least one of an object, a shape, a size, a color, and a material in a real space. Thus, information used in AR processing increases, thereby extending the range of video expression of augmented reality.

### 2. Modification Example

### (Display and Edit of Polygon Mesh)

In the information processing device 10, processing is performed such that a real space is 3D scanned and is modeled by the polygon mesh structure and the polygon mesh is replaced with contents, so that an augmented reality video is displayed on the display 105. For example, a 3D scan of a real space is started by a user operation of an AR application. At this point, a video of the polygon mesh may be displayed on the display 105 after the 3D scan of a real space is started and before the polygon mesh is replaced with the contents.

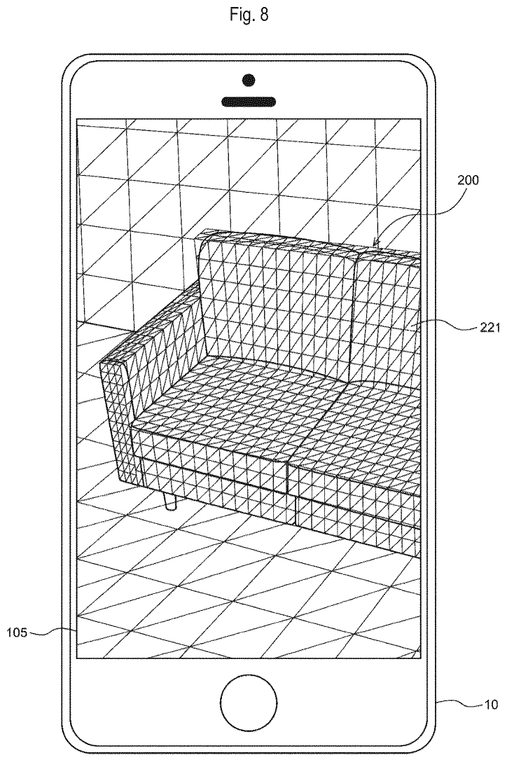

FIG. 8 shows a display example of the AR application. In FIG. 8, a video of a sofa, a wall, and a floor that are expressed by a polygon mesh 221 in a room is displayed on the display 105. In other words, the display example of FIG. 8 shows an intermediate state between the captured video of FIG. 6 and the augmented reality video of FIG. 7 on a time-series basis.

Furthermore, the AR application may provide the edit function of a polygon mesh. For example, when a user performs an editing operation on the polygon mesh 221 in FIG. 8 with a finger touch or the like, the polygon mesh 221 may be processed (deformed) in response to the editing operation. Relevant data may be recorded in the auxiliary memory 103 to edit the polygon mesh 221 later, and then the polygon mesh 221 may be edited on the basis of the data read from the auxiliary memory 103. Alternatively, an edit of the polygon mesh 221 may be proposed to the user from the AR application.

### (Storage of Scan Information)

The information processing device 10 can record, in the auxiliary memory 103, scan result data obtained by a 3D scan of a real space. The scan result data may be transmitted to a server on the Internet, may be recorded in the server, and may be acquired when necessary. The scan result data is stored in this way, so that when a user visits a scanned real space again, an augmented reality video can be displayed on the basis of the stored scan result data in the information processing device 10.

At this point, the information processing device 10 does not need to perform a 3D scan on a real space, thereby reducing a processing load and shortening a time to the display of an augmented reality video. Whether a user has visited the same location or not may be determined by using information such as location information and sensing information.

### Example of Another Electronic Device

In the foregoing description, the information processing device 10 is a mobile computing device, e.g., a smartphone. The information processing device 10 may be another electronic device, for example, an HMD (Head Mounted Display), a wearable device, or a PC (Personal Computer).

### (Use of Cloud)

In the foregoing description, the auxiliary memory 103 records data on contents such as an AR object in the information processing device 10. The data on contents may be recorded in a server on a network, e.g., the Internet and may be acquired when necessary.

Another embodiment of the present disclosure may have a configuration of cloud computing in which one function is shared and cooperatively processed by a plurality of devices through a network. Specifically, at least some of the functions of the functional configuration example of the information processing device 10 in FIG. 2 may be provided for a cloud server. For example, processing for performing a 3D scan on a real space and forming a polygon mesh can be performed by the local information processing device 10, and the subsequent AR processing can be performed by the cloud server. Alternatively, the cloud server may be provided with all the functions of the functional configuration example of the information processing device 10 in FIG. 2. For example, the local information processing device 10 transmits, to the cloud server, information obtained from various sensors or the like, so that the processing shown in the flowcharts of FIGS. 4 and 5 is performed by the cloud server. The processing result from the cloud server is transmitted to the local information processing device 10, and then an augmented reality video is displayed.

### Another Configuration Example

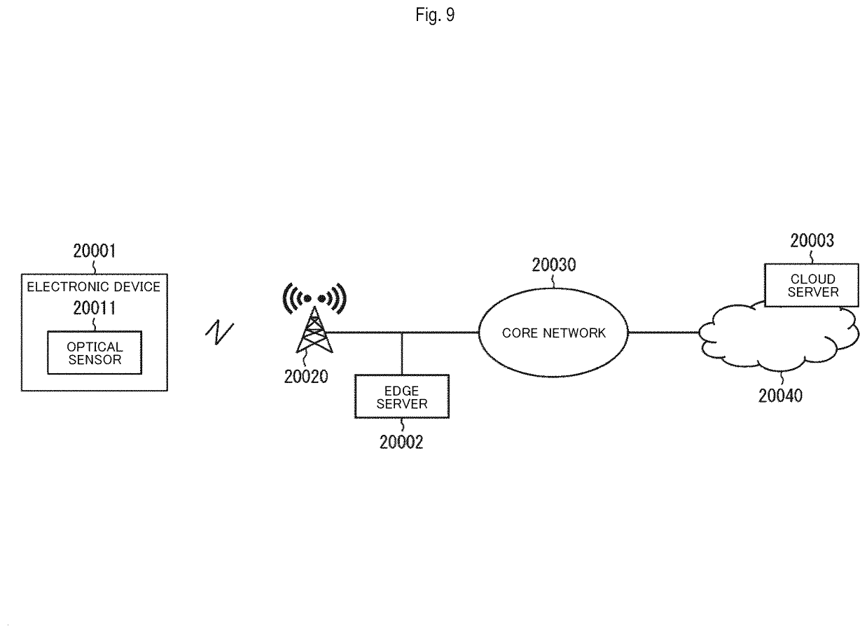

FIG. 9 illustrates a configuration example of a system including a device that performs processing to which the present disclosure is applied.

An electronic device 20001 is a mobile terminal, e.g., a smartphone, a tablet-type terminal, or a mobile phone. The electronic device 20001 corresponds to, for example, the information processing device 10 of FIG. 1 and includes an optical sensor 20011 corresponding to the RGB sensor 108 (FIG. 1) and the range sensor 110 (FIG. 1). The optical sensor is a sensor (image sensor) that converts light into an electric signal. The electronic device 20001 is connected to a base station 20020 at a predetermined location through radio communications in compliance with a predetermined communication scheme, so that the electronic device 20001 can be connected to a network 20040, e.g., the Internet via a core network 20030.

An edge server 20002 for implementing mobile edge computing (MEC) is provided at a position close to the mobile terminal, for example, a position between the base station 20020 and the core network 20030. A cloud server 20003 is connected to the network 20040. The edge server 20002 and the cloud server 20003 can perform various kinds of processing in accordance with purposes. Note that the edge server 20002 may be provided inside the core network 20030.

The electronic device 20001, the edge server 20002, the cloud server 20003, or the optical sensor 20011 perform processing to which the present disclosure is applied. The processing to which the present disclosure is applied includes at least any one of the steps shown in the flowcharts of FIGS. 4 and 5.

In the electronic device 20001, the edge server 20002, the cloud server 20003, or the optical sensor 20011, the processing to which the present disclosure is applied is implemented by executing a program through processors such as a CPU (Central Processing Unit) or using dedicated hardware such as a processor for a specific use. For example, a GPU (Graphics Processing Unit) may be used as the processor for a specific use.

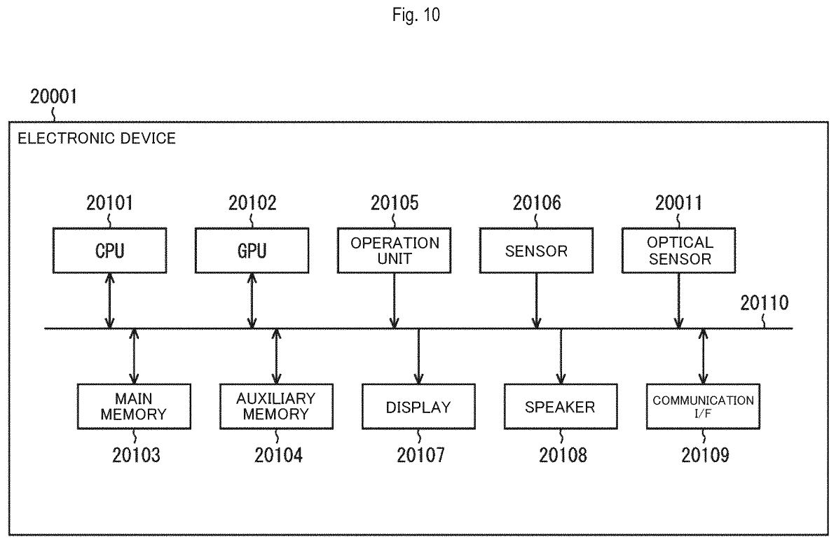

FIG. 10 illustrates a configuration example of the electronic device 20001. The electronic device 20001 includes a CPU 20101 that controls an operation of each unit and performs various kinds of processing, a GPU 20102 that is specialized in image processing and parallel processing, a main memory 20103, for example, a DRAM (Dynamic Random Access Memory), and an auxiliary memory 20104, for example, a flash memory.

The auxiliary memory 20104 records data including a program for processing to which the present disclosure is applied and various parameters. The CPU 20101 develops the program and the parameters, which are recorded in the auxiliary memory 20104, into the main memory 20103 and executes the program. Alternatively, the CPU 20101 and the GPU 20102 develop the program and the parameters, which are recorded in the auxiliary memory 20104, into the main memory 20103 and executes the program. Thus, the GPU 20102 can be used as GPGPUs (General-Purpose computing on Graphics Processing Units).

The CPU 20101 and the GPU 20102 may be each configured as a SoC (System on a Chip). In the case where the CPU 20101 executes the program for AI processing to which the present disclosure is applied, the GPU 20102 may be omitted.

In addition, the electronic device 20001 includes the optical sensor 20011, an operation unit 20105 that includes physical buttons and a touch panel, a sensor 20106 that includes at least one sensor, a display 20107 that displays information such as an image and text, a speaker 20108 that outputs a sound, a communication I/F 20109, e.g., a communication module compliant with a predetermined communication scheme, and a bus 20110 connecting the units.

The sensor 20106 includes at least one of various sensors including an optical sensor (image sensor), a sound sensor (microphone), a vibration sensor, an acceleration sensor, an angular velocity sensor, a pressure sensor, an odor sensor, and a biological sensor. In the processing to which the present disclosure is applied, data acquired from at least one sensor of the sensor 20106 can be used with data (image data) acquired from the optical sensor 20011. In other words, the optical sensor 20011 corresponds to the RGB sensor 108 (FIG. 1) and the range sensor 110 (FIG. 1), and the sensor 20106 corresponds to the IMU 109 (FIG. 1).

Moreover, data acquired from two or more optical sensors by a sensor fusion technique or integrated data thereof may be used for the processing to which the present disclosure is applied. The two or more optical sensors may be a combination of the optical sensor 20011 and the optical sensor in the sensor 20106 or a plurality of sensors included in the optical sensor 20011. For example, the optical sensor includes a visible light sensor of RGB, a range sensor of ToF (Time of Flight) or the like, a polarization sensor, an event-based sensor, a sensor for acquiring an IR image, and a sensor capable of acquiring a multiwavelength.

In the electronic device 20001, processors such as the CPU 20101 and the GPU 20102 can perform the processing to which the present disclosure is applied. In the case where the processor of the electronic device 20001 performs the processing to which the present disclosure is applied, the processing can be started without requiring a time after the optical sensor 20011 acquires image data, achieving high-speed processing. Therefore, in the electronic device 20001, a user can perform an operation without any uncomfortable feeling due to a delay when the processing is used for the use of an application that requires transmission of information with a short delay time. Furthermore, in the case where the processor of the electronic device 20001 performs the processing to which the present disclosure is applied, the processing can be implemented at low cost while eliminating the need for using a communication line and a computer device for a server unlike in the use of servers such as the cloud server 20003.

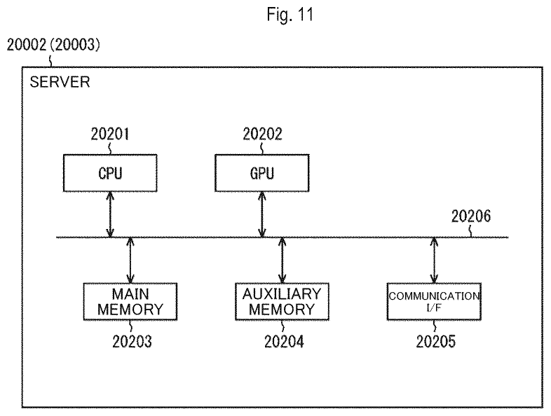

FIG. 11 illustrates a configuration example of the edge server 20002. The edge server 20002 includes a CPU 20201 that controls an operation of each unit and performs various kinds of processing, and a GPU 20202 that is specialized in image processing and parallel processing. The edge server 20002 further includes a main memory 20203, e.g., a DRAM, an auxiliary memory 20204, e.g., HDD (Hard Disk Drive) or a SSD (Solid State Drive), and a communication I/F 20205, e.g., an NIC (Network Interface Card), and these units are connected to a bus 20206.

The auxiliary memory 20204 records data including a program for processing to which the present disclosure is applied and various parameters. The CPU 20201 develops the program and the parameters, which are recorded in the auxiliary memory 20204, into the main memory 20203 and executes the program. Alternatively, the GPU 20202 can be used as a GPGPU by the CPU 20201 and the GPU 20202 developing the program and the parameters recorded in the auxiliary memory 20204 in the main memory 20203 and executing the program. In the case where the CPU 20201 executes the program for the processing to which the present disclosure is applied, the GPU 20202 may be omitted.

In the edge server 20002, processors such as the CPU 20201 and the GPU 20202 can perform the processing to which the present disclosure is applied. In the case where the processor of the edge server 20002 performs the processing to which the present disclosure is applied, the edge server 20002 is provided at a position closer to the electronic device 20001 than the cloud server 20003, thereby reducing a delay of the processing. Also, the edge server 20002 has a higher throughput, e.g., a computing speed as compared with the electronic device 20001 and the optical sensor 20011 and can thus be configured for a general purpose. Therefore, in the case where the processor of the edge server 20002 performs the processing to which the present disclosure is applied, the processing to which the present disclosure is applied can be performed if data can be received, regardless of a difference in the specifications and performance of the electronic device 20001 and the optical sensor 20011. In the case where the edge server 20002 performs the processing to which the present disclosure is applied, a processing load in the electronic device 20001 and the optical sensor 20011 can be reduced.

The configuration of the cloud server 20003 is identical to the configuration of the edge server 20002 and thus the description thereof is omitted.

In the cloud server 20003, processors such as the CPU 20201 and the GPU 20202 can perform the processing to which the present disclosure is applied. The cloud server 20003 has a higher throughput, e.g., a computing speed as compared with the electronic device 20001 and the optical sensor 20011 and can thus be configured for a general purpose. Therefore, in the case where the processor of the cloud server 20003 performs the processing to which the present disclosure is applied, the processing to which the present disclosure is applied can be performed regardless of a difference in the specifications and performance of the electronic device 20001 and the optical sensor 20011. Furthermore, if it is difficult for the processor of the electronic device 20001 or the optical sensor 20011 to perform the processing to which the present disclosure is applied with a heavy load, the processor of the cloud server 20003 can perform the processing to which the present disclosure is applied with a heavy load, and provide a feedback of the processing result to the processor of the electronic device 20001 or the optical sensor 20011.

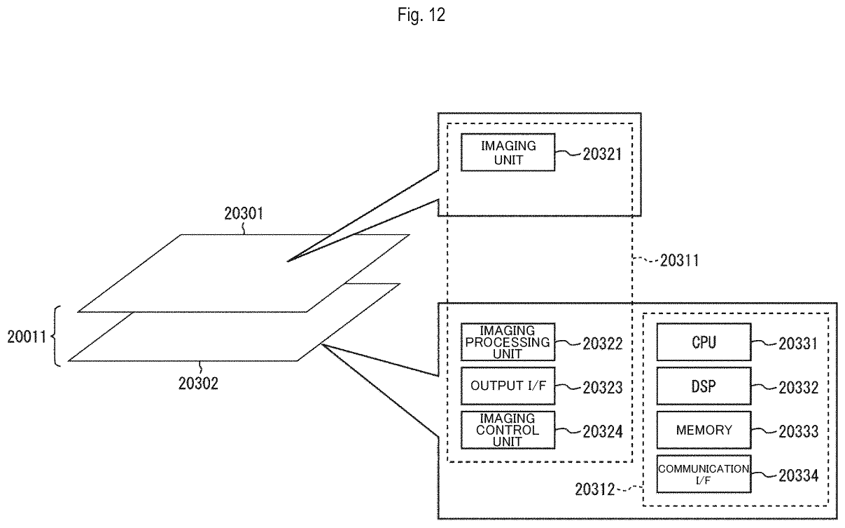

FIG. 12 illustrates a configuration example of the optical sensor 20011. The optical sensor 20011 can be configured as, for example, a semiconductor device of one chip having a laminated structure in which a plurality of substrates are stacked. The optical sensor 20011 is configured such that a substrate 20301 and a substrate 20302 are stacked. The configuration of the optical sensor 20011 is not limited to a laminated structure. For example, a substrate including an imaging unit may include a processor of a CPU or a DSP (Digital Signal Processor) for performing the processing to which the present disclosure is applied.

An imaging unit 20321 configured with a plurality of two-dimensionally arranged pixels is mounted on the upper substrate 20301. An imaging processing unit 20322 that performs processing for the capturing of an image in the imaging unit 20321, an output I/F 20323 that outputs a captured image and a signal processing result to the outside, and an imaging control unit 20324 that controls the capturing of an image in the imaging unit 20321 are mounted on the lower substrate 20302. The imaging unit 20321, the imaging processing unit 20322, the output I/F 20323, and the imaging control unit 20324 constitute an imaging block 20311.

Mounted in the lower substrate 20302 are a CPU 20331 that controls each unit and performs various kinds of processing, a DSP 20332 that performs signal processing using a captured image and information from the outside, a memory 20333, e.g., a SRAM (Static Random Access Memory) or a DRAM (Dynamic Random Access Memory), and a communication I/F 20334 that exchanges necessary information with the outside. The CPU 20331, the DSP 20332, the memory 20333, and the communication I/F 20334 constitute a signal processing block 20312. At least one processor out of the CPU 20331 and the DSP 20332 can perform the processing to which the present disclosure is applied.

As described above, the signal processing block 20312 for the processing to which the present disclosure is applied can be mounted on the lower substrate 20302 in the laminated structure in which a plurality of substrates are stacked. Thus, image data acquired by the imaging block 20311 mounted for imaging on the upper substrate 20301 is processed by the signal processing block 20312 mounted for the processing to which the present disclosure is applied on the lower substrate 20302, thereby performing the series of processing in the one-chip semiconductor device.

In the optical sensor 20011, the processor of the CPU 20331 or the like can perform the processing to which the present disclosure is applied. In the case where the processor of the optical sensor 20011 performs the processing to which the present disclosure is applied, the series of processing is performed in the one-chip semiconductor device. This prevents information from leaking to the outside of the sensor and thus enhances the confidentiality of the information. Moreover, the need for transmitting data such as image data to another device is eliminated, so that in the processor of the optical sensor 20011, the processing to which the present disclosure is applied, for example, processing using image data can be performed at a high speed. For example, when the processing is used for the use of an application that requires a real-time quality, the real-time quality can be sufficiently secured. In this case, to secure the real-time quality indicates that information can be transmitted with a short delay time. Moreover, when the processor of the optical sensor 20011 performs the processing to which the present disclosure is applied, various kinds of meta data are delivered by the processor of the electronic device 20001, so that the processing can be reduced to obtain low power consumption.

The processing executed by the computer (the processor of a CPU or the like) in accordance with the program described herein may not necessarily be executed chronologically in the order described as the flowcharts. In other words, the processing executed by the computer in accordance with the program also includes processing that is executed in parallel or individually (for example, parallel processing or processing by objects). The program may be processed by a single computer (the processor of a CPU or the like) or processed in a distributed manner by a plurality of computers.

Note that an embodiment of the present disclosure is not limited to that described and can be modified in various manners without departing from the gist of the present disclosure. The advantageous effects described in the present specification are merely exemplary and are not limited, and other advantageous effects may be obtained.

The present disclosure can be also configured as follows:

(1)

An information processing device including a processing unit that performs processing for replacing an area corresponding to a real space with associated contents on the basis of a scan result obtained by a 3D scan of the real space,
wherein the processing unit associates the contents with the area corresponding to the real space, on the basis of information about at least one of an object, a shape, a size, a color, and a material in the real space.
   (2)

The information processing device according to (1), further including a recording unit that records the contents.

(3)

The information processing device according to (1) or (2), wherein the processing unit associates the contents with an area having a specific object on the basis of information about the object.

(4)

The information processing device according to (1) or (2), wherein the processing unit associates the contents with an area having a specific shape on the basis of information about the shape.

(5)

The information processing device according to (1) or (2), wherein the processing unit associates the contents with an area having a specific size on the basis of information about the size.

(6)

The information processing device according to (1) or (2), wherein the processing unit associates the contents with an area having a specific color on the basis of information about the color.

(7)

The information processing device according to (1) or (2), wherein the processing unit associates the contents with an area having a specific material on the basis of information about the material.

(8)

The information processing device according to (3), wherein the object is recognized on the basis of a captured image captured by an image sensor.

(9)

The information processing device according to (4), wherein the shape is recognized on the basis of a captured image captured by an image sensor, acceleration information measured by an IMU, and distance measurement information measured by a range sensor.

(10)

The information processing device according to (5), wherein the size is recognized on the basis of a captured image captured by an image sensor, acceleration information measured by an IMU, and distance measurement information measured by a range sensor.

(11)

The information processing device according to (6), wherein the color is recognized on the basis of a captured image captured by an image sensor.

(12)

The information processing device according to (7), wherein the material is recognized on the basis of a captured image captured by an image sensor and distance measurement information measured by a range sensor.

(13)

The information processing device according to any one of (1) to (12), wherein the processing unit further performs at least one of processing for generating an object disposed in an area corresponding to the real space and processing for creating an effect on an area corresponding to the real space.

(14)

The information processing device according to (13), wherein the processing unit processes the contents on the basis of additional information acquired via a network.

(15)

The information processing device according to (14), wherein the additional information includes information about at least one of a weather and a time.

(16)

The information processing device according to any one of (1) to (15), further including a display unit that displays a video in which an area corresponding to the real space is replaced with the contents.

(17)

The information processing device according to (16), wherein the processing unit performs processing such that the real space is 3D scanned and is modeled by a polygon mesh structure and a polygon mesh is replaced with the contents, and the display unit displays a video of the polygon mesh after a 3D scan of the real space is started and before the polygon mesh is replaced with the contents.

(18)

The information processing device according to (17), wherein the processing unit processes the polygon mesh in response to an edit operation by a user.

(19)

An information processing method causing an information processing device to: perform processing for replacing an area corresponding to a real space with associated contents on the basis of a scan result obtained by a 3D scan of the real space, and associate the contents with the area corresponding to the real space, on the basis of information about at least one of an object, a shape, a size, a color, and a material in the real space.

(20)

A program causing a computer to function as:
an information processing device including a processing unit that performs processing for replacing an area corresponding to a real space with associated contents on the basis of a scan result obtained by a 3D scan of the real space,
wherein the processing unit associates the contents with the area corresponding to the real space, on the basis of information about at least one of an object, a shape, a size, a color, and a material in the real space.

### REFERENCE SIGNS LIST

10 Information processing device
100 CPU
101 GPU
102 Main memory
103 Auxiliary memory
104 Operation system
105 Display
106 Speaker
107 Communication I/F
108 RGB sensor
109 IMU
110 Range sensor
111 GPS
151 RGB image acquisition unit
152 Acceleration information acquisition unit
153 Distance-measurement information acquisition unit
154 Location information acquisition unit
155 Weather information acquisition unit
156 Time information acquisition unit
157 Object detection unit
158 SLAM processing unit
159 Point cloud generation unit
160 Modeling unit
161 3D object/material recognition unit
162 Mesh clustering unit
163 Shape recognition unit
164 Semantic segmentation unit
165 AR processing unit
191 Object generation unit
192 Morphing unit
193 Effect processing unit

1. An information processing device comprising a processing unit that performs processing for replacing an area corresponding to a real space with associated contents on a basis of a scan result obtained by a 3D scan of the real space,
wherein the processing unit associates the contents with the area corresponding to the real space, on a basis of information about at least one of an object, a shape, a size, a color, and a material in the real space.

2. The information processing device according to claim 1, further comprising a recording unit that records the contents.

3. The information processing device according to claim 1, wherein the processing unit associates the contents with an area having a specific object on a basis of information about the object.

4. The information processing device according to claim 1, wherein the processing unit associates the contents with an area having a specific shape on a basis of information about the shape.

5. The information processing device according to claim 1, wherein the processing unit associates the contents with an area having a specific size on a basis of information about the size.

6. The information processing device according to claim 1, wherein the processing unit associates the contents with an area having a specific color on a basis of information about the color.

7. The information processing device according to claim 1, wherein the processing unit associates the contents with an area having a specific material on a basis of information about the material.

8. The information processing device according to claim 3, wherein the object is recognized on a basis of a captured image captured by an image sensor.

9. The information processing device according to claim 4, wherein the shape is recognized on a basis of a captured image captured by an image sensor, acceleration information measured by an IMU, and distance measurement information measured by a range sensor.

10. The information processing device according to claim 5, wherein the size is recognized on a basis of a captured image captured by an image sensor, acceleration information measured by an IMU, and distance measurement information measured by a range sensor.

11. The information processing device according to claim 6, wherein the color is recognized on a basis of a captured image captured by an image sensor.

12. The information processing device according to claim 7, wherein the material is recognized on a basis of a captured image captured by an image sensor and distance measurement information measured by a range sensor.

13. The information processing device according to claim 1, wherein the processing unit further performs at least one of processing for generating an object disposed in an area corresponding to the real space and processing for creating an effect on an area corresponding to the real space.

14. The information processing device according to claim 13, wherein the processing unit processes the contents on a basis of additional information acquired via a network.

15. The information processing device according to claim 14, wherein the additional information includes information about at least one of a weather and a time.

16. The information processing device according to claim 1, further comprising a display unit that displays a video in which an area corresponding to the real space is replaced with the contents.

17. The information processing device according to claim 16, wherein the processing unit performs processing such that the real space is 3D scanned and is modeled by a polygon mesh structure and a polygon mesh is replaced with the contents, and
the display unit displays a video of the polygon mesh after a 3D scan of the real space is started and before the polygon mesh is replaced with the contents.

18. The information processing device according to claim 17, wherein the processing unit processes the polygon mesh in response to an edit operation by a user.

19. An information processing method causing an information processing device to: perform processing for replacing an area corresponding to a real space with associated contents on a basis of a scan result obtained by a 3D scan of the real space, and associate the contents with the area corresponding to the real space, on a basis of information about at least one of an object, a shape, a size, a color, and a material in the real space.

20. A program causing a computer to function as:
an information processing device comprising a processing unit that performs processing for replacing an area corresponding to a real space with associated contents on a basis of a scan result obtained by a 3D scan of the real space,
wherein the processing unit associates the contents with the area corresponding to the real space, on a basis of information about at least one of an object, a shape, a size, a color, and a material in the real space.
